(19) United States
(12) Patent Application Publication
(10) Pub. No.: US 2017/0068675 A1
(43) Pub. Date: Mar. 9, 2017

(54) METHOD AND SYSTEM FOR ADAPTING A DATABASE KERNEL USING MACHINE LEARNING

(71) Applicant: DEEP INFORMATION SCIENCES, INC., Boston, MA (US)

(72) Inventors: Thomas HAZEL, Andover, MA (US); Eric MANN, Dover, NH (US); David NOBLET, Londenderry, NH (US); Gerard BUTEAU, Durham, NH (US)

(21) Appl. No.: 15/209,400

(22) Filed: Jul. 13, 2016

Related U.S. Application Data
(60) Provisional application No. 62/214,134, filed on Sep. 3, 2015.

(51) Int. Cl. G06F 17/30; G06N 99/00

(52) U.S. Cl. CPC G06F 17/3056; G06N 99/005

(57) ABSTRACT

A method, a system, and a computer program product for adaptively managing information in a database management system are provided. The system generates a model associated with the database management system. The system receives information for performing a database. The system determines, based on the generated model and the database transaction, whether to adjust an attribute associated with the database management system.

### CROSS-REFERENCE TO RELATED APPLICATION(S)

This Application Claims the Benefit of U.S. Provisional Application No. 62/214,134 entitled, “METHOD AND SYSTEM FOR ADAPTING A DATABASE KERNEL USING MACHINE LEARNING,” filed on Sep. 3, 2015, which is expressly incorporated by reference herein in its entirety.

### BACKGROUND

Field

The present disclosure relates generally to a method, apparatus, system, and computer readable media for an adaptive database kernel using machine learning techniques, and more particularly, relates to using machine learning to continually construct and/or organize data using dynamic, independent structures and/or algorithms in order to minimize read/write computational costs.

Description of the Related Art

Information storage may be based on two fundamental algorithms: B-Tree and Log-structured merge-tree (LSM-Tree). Many LSM implementations actually use B-Tree(s) internally. These algorithms and their corresponding fixed data structures have been the foundation of many Row-Oriented, Column-Oriented, Document-Oriented, and File-System database architectures.

Although there are variants to the B-Tree and LSM-Tree designs, both have specific behaviors assigned to handle particular use-cases. For instance, B-Tree(s) are typically designed to operate as “read-optimized” algorithms and LSM-Tree(s) are typically designed to operate as “write-optimized”. Each algorithm is associated with Big-O-Notation, which is used to articulate efficiency, or “cost” of an algorithm to Create, Read, Update, and Delete (CRUD) information, where random (i.e. unordered) information is more costly to operate on than sequential (i.e. ordered) information. In database design, “cost” is most often associated to information manipulation such as read/write/access operations that may be performed in physical storage. Accordingly, limiting such costly operations such as seek time or write amplification is key to improving performance.

To get around the limitations posed by B-Tree and LSM-Tree algorithms and reduce their overall cost, architects have implemented pre and post workarounds. For instance, Row-Oriented architectures such as Relational Database Management System(s) (RDBMS) have introduced Write-ahead logging (WAL), which appends a Log-File in front of the underlying B-Tree so that information can be pre-organized to limit the cost of writes (e.g., writes requiring reads). On the contrary, LSM-Tree architectures typically use blind writes (e.g., writes not requiring reads) and post-organize information via log merge leveling to limit the cost of subsequent reads.

Each implementation has distinct performance metrics. On average B-Tree(s) are typically 2× faster than LSM-Tree(s) on reads and LSM-Tree(s) are typically 2× faster than B-Tree(s) on writes. Yet what is sometimes missed in such metrics is where the testing is done. For instance, a Row-Oriented architecture such as that of MySQL has atomicity, consistency, isolation, and durability (ACID) requirements that put a greater burden on the underlying B-Tree than, for example, the underlying B-Tree of a Document-Oriented architecture such as MongoDB. Moreover, comparing an architecture like MySQL to, for example, a Column-Oriented architecture such as Cassandra becomes more problematic because not only are the requirements different so are the underlying algorithms (B-Tree vs. LSM-Tree respectively).

Therefore, if MySQL could outperform Cassandra on a write heavy use-case or vice versa, Cassandra could outperform MySQL on read heavy use-cases. Typically the underlying algorithm “hits a wall” due to its degenerate use-case and the performance cost of physical storage. Therefore, it is difficult to implement an algorithm to limit reads (seek) and/or writes (amplification) to a theoretical minimum.

### SUMMARY

In light of the above described problems and unmet needs as well as others, systems and methods are presented for providing an adaptive kernel database that utilizes machine learning to optimize read/write computational cost.

For example, aspects presented herein provide advantages such as achieving a theoretical minimum “cost” and thus obtain maximum performance in both write and read operations. Aspects presented herein provide for the continual construction and/or organization of data using dynamic, independent structures and/or algorithms.

For instance, the performance of writes (single or grouped) may have a seek cost of “0.” Moreover, performance of reads (point or scan) may have seek cost of “1.” Storage organization algorithms and data structures may maximize both processor and memory resources to continuously achieve such requirements.

Aspects may be used as a standalone transactional database supporting all aspects of

ACID or as a storage engine used in connection with other storage structures, e.g., used in connection with Row-Oriented, Column-Oriented, Document-Oriented, and even File-System architectures.

Additional advantages and novel features of these aspects will be set forth in part in the description that follows, and in part will become more apparent to those skilled in the art upon examination of the following or upon learning by practice of the invention.

### BRIEF DESCRIPTION OF THE DRAWINGS

Various aspects of the systems and methods will be described in detail, with reference to the following figures, wherein:

FIG. 1 presents an example system diagram of various hardware components and other features, for use in accordance with aspects of the present invention.

FIG. 2 is a block diagram of various example system components, in accordance with aspects of the present invention.

FIG. 3 conceptually illustrates a process for adaptively managing information in a DBMS in accordance with aspects of the present invention.

FIG. 4 conceptually illustrates a process for generating a model utilizing machine learning techniques.

FIG. 5 conceptually illustrates a process for generating a model where on disk information is isolated from in memory information.

FIG. 6 presents a flow chart illustrating aspects of an automated method of adaptively managing information in a DBMS, in accordance with aspects of the present invention.

FIG. 7 illustrates a flow chart of receiving and processing read requests for information in accordance with aspects of the present invention.

FIG. 8 illustrates a flow chart of receiving and processing write requests for information in accordance with aspects of the present invention.

FIG. 9A illustrates an exemplary adaptive control structure within a DBMS logical tree structure.

FIG. 9B illustrates a state diagram of how a segment may change state or maintain the same state.

FIG. 10 illustrates a flow chart of handling segment changes in accordance with aspects of the present invention.

FIGS. 11A and 11B illustrate flow charts of memory management in accordance with aspects of the present invention.

FIG. 12 illustrates a flow chart of receiving and processing a LRT/VRT file defragmentation request in accordance with aspects of the present invention.

### DETAILED DESCRIPTION

These and other features and advantages in accordance with aspects of this invention are described in, or will become apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof. The term “and/or” includes any and all combinations of one or more of the associated listed items.

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Several aspects of systems capable of providing optimized, sequential representations of information for both disk and memory, in accordance with aspects of the present invention will now be presented with reference to various apparatuses and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

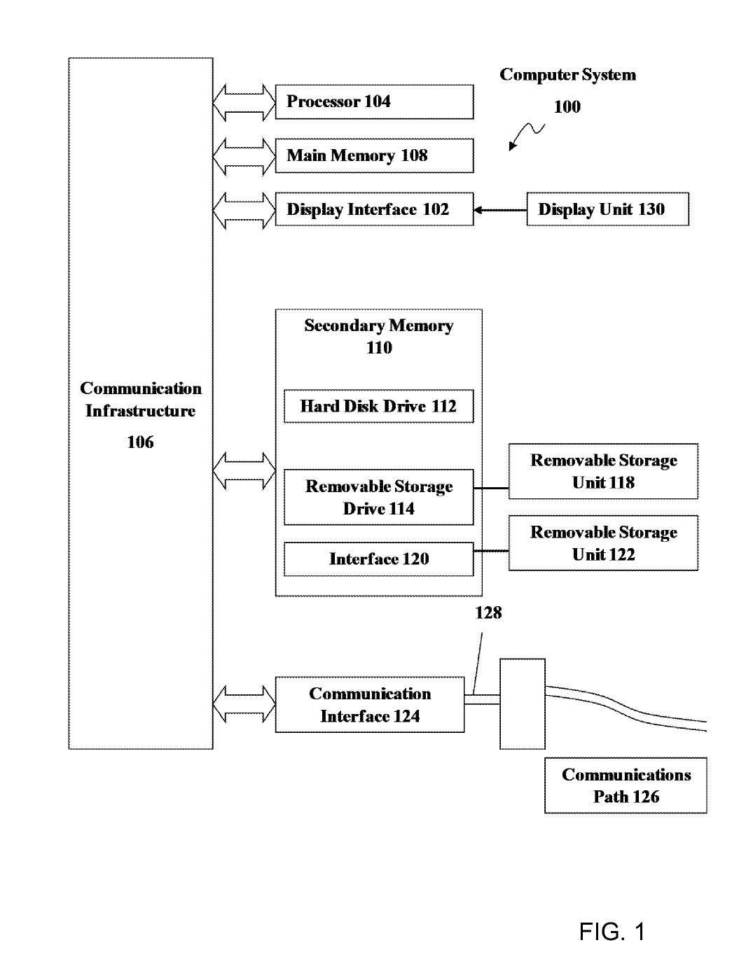

FIG. 1 presents an example system diagram of various hardware components and other features, for use in accordance with an example implementation in accordance with aspects of the present invention. Aspects of the present invention may be implemented using hardware, software, or a combination thereof, and may be implemented in one or more computer systems or other processing systems. In one implementation, aspects of the invention are directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software implementations are described in terms of this example computer system. After reading this description, it will become apparent to a person skilled in the relevant art(s) how to implement aspects of the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably RAM, and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative implementations, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an EPROM, or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. Aspects of the invention are directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features in accordance with aspects of the present invention, as discussed herein. In particular, the computer programs, when executed, enable the processor 110 to perform various features. Accordingly, such computer programs represent controllers of the computer system 100.

In an implementation where aspects of the invention are implemented using software, the software may be stored in a computer program product and loaded into computer system 100 using removable storage drive 114, hard drive 112, or communications interface 120. The control logic (software), when executed by the processor 104, causes the processor 104 to perform various functions as described herein. In another implementation, aspects of the invention are implemented primarily in hardware using, for example, hardware components, such as application specific integrated circuits (ASICs) Implementation of the hardware state machine so as to perform the functions described herein will be apparent to persons skilled in the relevant art(s).

In yet another implementation, aspects of the invention are implemented using a combination of both hardware and software.

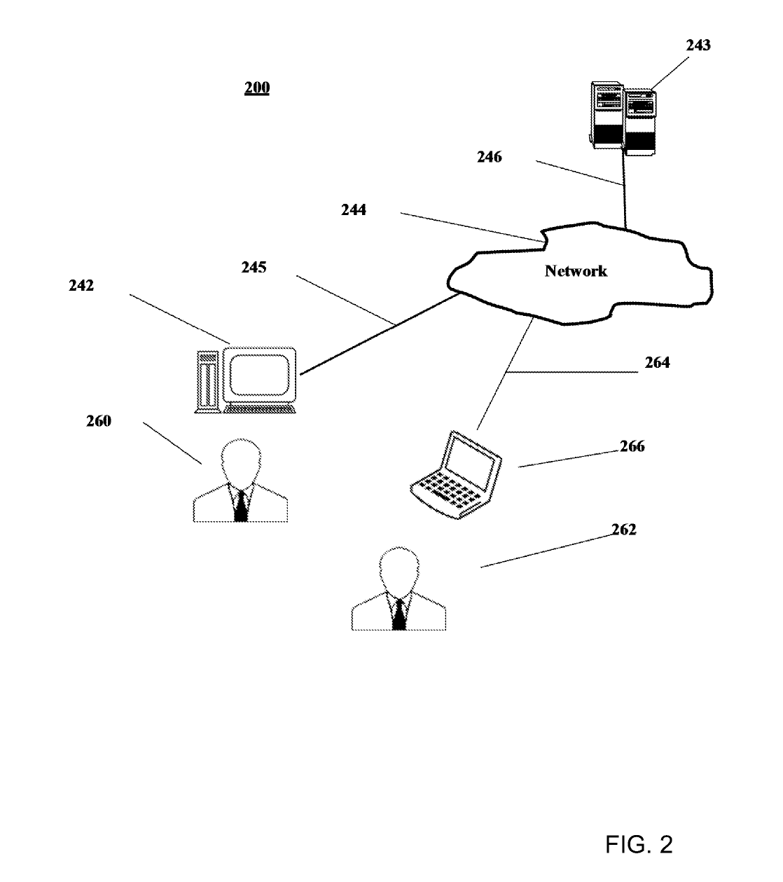

FIG. 2 is a block diagram of various example system components, in accordance with aspects of the present invention. FIG. 2 shows a communication system 200 usable in accordance with the aspects presented herein. The communication system 200 includes one or more accessors 260, 262 (also referred to interchangeably herein as one or more “users” or clients) and one or more terminals 242, 266. In an implementation, data for use in accordance with aspects of the present invention may be, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links.

Aspects described herein provide a database management system (DBMS) utilizing continuous adaptive sequential summarization of information. Aspects may be applied, e.g., to cloud computing. Aspects include continually constructing and organizing data with dynamic and independent structures and/or algorithms in order to minimize computational and/or read/write costs. For instance, some aspects provide a DBMS that combines the performance benefits of B-Tree and/or a log-structured merge-tree (LSM Tree) along with machine based learned to maximize performance and minimize read/write cost in a dynamic, independent manner. In such instances, the behavior and structure of trees may be separated in order to realize greater performance gains. For instances, B-Trees are designed around specific structures and algorithms. In some aspects of the DBMS it may be possible to utilize performance benefits similar to those associated with the B-trees and LSM-trees such as just read and write optimizations to realize optimal performance through minimal read/write cost. Moreover, those skilled in the art will recognize that discussion relating to the performance benefits realized in the foregoing sections are not limited to using the performance benefits from structures and algorithms associated with B-Trees or LSM-Trees. In fact, any suitable data structure or database algorithm may be utilized without departing from the spirit of the described invention.

Performance benefits may be measured using big O notation. Big O notation describes a function according to a growth rate. For instance, big O notation may describe the upper bound of a function. In databases, big O notation may be written as O(time), where time is the amount of time an operation takes to run. In some instances O(time) may describe the seek count of an operation. For instance a database operation may have a seek count of O(n), meaning that the operation requires linear seek time. However, big O notation does not account for constants. Thus, as will be shown in the foregoing, a first operation having the same seek count as a second operation may perform better.

The following description may apply to several different database architectures such as row-oriented architectures, column-oriented architectures, document-oriented architectures, and object-oriented architectures. However, one of ordinary skill in the art will recognize that the foregoing features are not limited to only the architectures above and may be applied to any suitable database architecture.

A datastore may be defined as a repository of a set of data objects. The data objects are managed by the DBMS according to machine learning and modeling techniques, which will be discussed in greater detail in the foregoing. Aspects additionally include a datastore that maintains an on-disk and in-memory representation of a key ordered map storing (key, value) tuples. Each key is unique and values may be associated with keys. Values may be added and modified by specifying the unique key and its associated value. The unique key used to modify the (key, value) relationship is known as the primary key. Composite, secondary, and non-unique keys (indexes) are also supported. Queries may be performed by exact key lookup as well as by key range. Efficient key range queries are enabled by tree-like in-memory data structures and ordered on-disk indexes. Group operations/transactions may be supported for all operations, e.g., Create, Read, Update, Delete (CRUD). Operations/transactions are Atomic, Consistent, Isolated and Durable (ACID). A database transaction may be defined as a sequence of operations performed as a single logical unit of work within a DBMS. For instance a single transaction may comprises one or more data manipulation(s) and queries, each performing read and/or write operations on data within the datastore. A transaction must complete in its entirety in order to be successful. Unsuccessful transactions, or transactions that produce an error, are typically rolled back such that the database is in the same state as it was prior to initiation of the transaction in order to leave the database in a consistent state.

Three main file types may be used in connection with the DBMS. Such file types may include real-time key logging files (LRT), real-time value logging files (VRT), and real-time key tree files (IRT). A detailed description of LRT, VRT, and IRT files as well as characteristics and management of such files is provided in co-pending U.S. patent application Ser. No. 13/781,339, now published as U.S. Patent Publication No. 2013/0226931. The entirety of U.S. Patent Publication No. 2013/0226931 is incorporated herein by reference. Additionally, aspects regarding indexing and transaction representation in such datastores is detailed in co-pending U.S. Patent Publication No. 2013/0254208 titled “Method and System for Indexing in Datastores,” and U.S. Patent Publication No. 2013/0290243 titled “Method and System for Transaction Representation in Append-Only Datastores,” the entire contents of each of which are incorporated herein by reference.

A datastore may comprise many LRT, VRT and IRT files, which are managed by the DBMS. There may be a 1-to-1 relationship between LRT and VRT files. IRT files may span multiple VRT files, for example, providing an ordered index of unordered values.

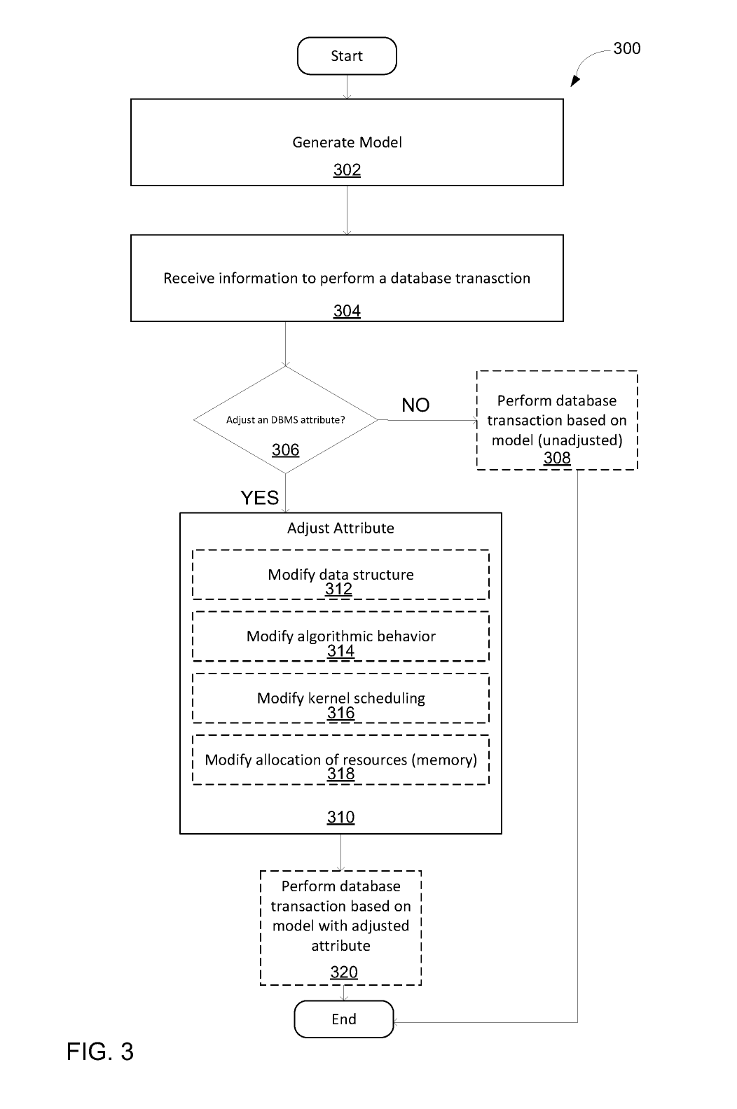

FIG. 3 conceptually illustrates a process 300 for adaptively managing information in a DBMS in accordance with aspects presented herein. Optional aspects are illustrated using a dashed line. The process 300 may be performed, e.g., by a communication component including any combination of processor 104, communication infrastructure 106, interface 120, communication interface 124, and communication path 126 in FIG. 1. The process 300 may begin after any state change within the DBMS. For instance, the process 300 may begin after information has been accessed, stored, and/or retrieved in a database. The process 300 may then generate (at 302) a model that utilizes machine learning techniques for determining and predicting an optimal organization and/or structure for information maintained in the DBMS. Such modeling techniques will be discussed in the foregoing paragraphs.

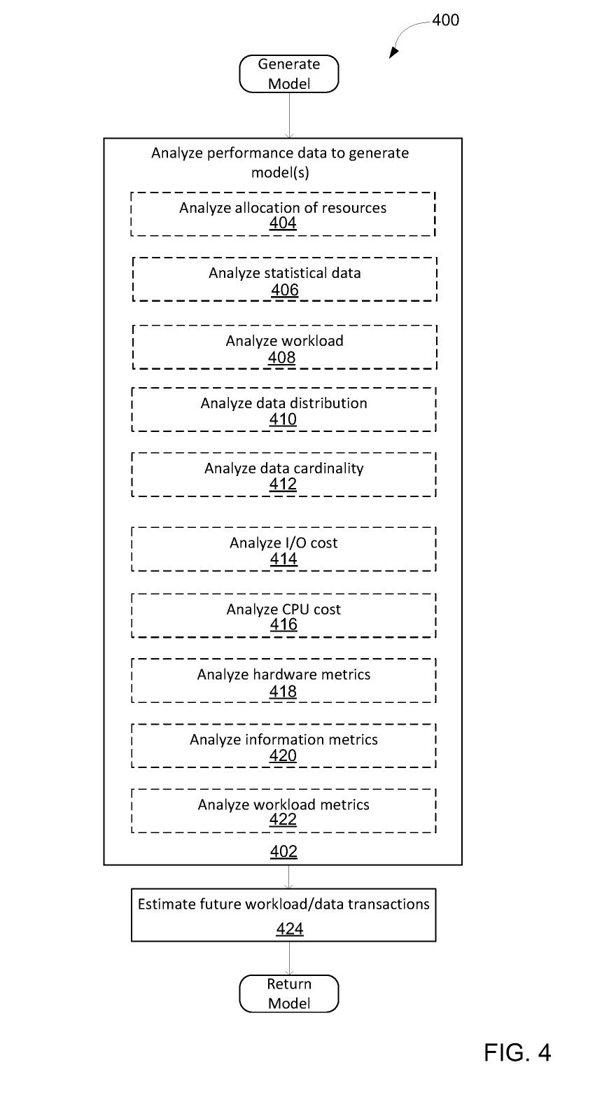

Using the generated model, at 306 a determination may be made whether to adjust an attribute of the DBMS. Such attributes may include algorithmic behavior, a data structure, such as a tree structure, kernel scheduling, and/or allocation of resources such as memory and on-disk storage. The determination may be based on a process that analyzes and/or aggregates different types of performance metrics and/or data. Such performance metrics or data may include, for example hardware metrics such as the number of CPUs in one or more client devices, context switching, the number of instructions processed per-second, number of storage drives, and/or I/O performance; such performance metrics may also include information metrics such as data distribution (e.g., sequential or random), cardinality, compression ratios, and types; such metrics may further include workload metrics such the number of database clients capable of spawning threads to assist with the database workload, the complexity and/or duration of database transactions at client systems, and/or internal thread scheduling in relation to the performance of adjusting various data attributes (e.g., splitting, merging, defragmenting, compressing). These metrics may be used to predict or estimate a database's future workload. For instance, if data being received by the database is primarily sequential, then the generated model may predict that future data received at the database will also be sequential. As a result, the generated model may cause the database to avoid any data reorganization while the input data remains substantially sequential. Conversely or conjunctively, the add operation (to update the tree with the received data) may not make any compares while constructing the tree because the data is sequential and thus has a cost of O(1). The above metrics and details about how the generated model may be used will be discussed in greater detail in FIGS. 4-12.

When the process 300 determines to adjust a DBMS attribute, the process 300 may adjust (at 310) one of the attributes 312-318. Thus, at 312, a modification may be made to a data structure of the generated model. For example, this may include changing the tree structure by changing the type and size of a segment. A segment type may be either physical, virtual, or summarized. Physical segments are fully instantiated branch subtrees with all items included. A virtual segment is a logical branch tree (e.g., not fully instantiated). A summary segment is a logical aggregation of segments, including physical or summarized segments that are recursively self-similar. Moreover, the number of items comprised in a segment (segment size) is another adaptive attribute where in-memory and/or on-disk representation may be used for determining concurrent access patterns, data capacity minimization, and overall memory and disk throughput.

At 314, a modification may be made to aspects of an algorithm used in organizing and storing data. For example, this may include changing the type of segment (e.g., physical, virtual, or summarized segments), where each type selects internal algorithms in support of C.R.U.D operations such as in-memory and/or on-disk operations.) as the actual segment reshaping (e.g., split, merge, reorder, compress, etc.) of the underlying data structure, in-memory and/or on-disk.

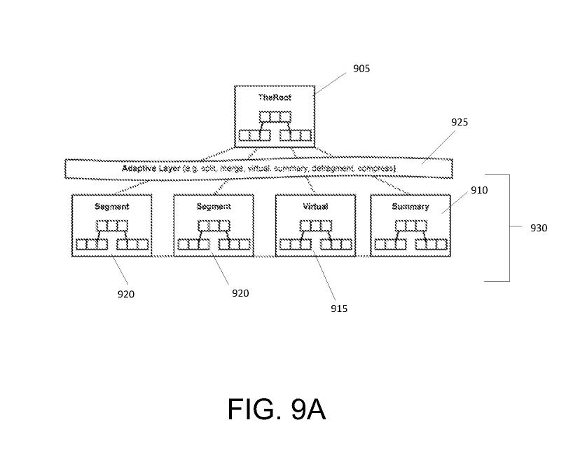

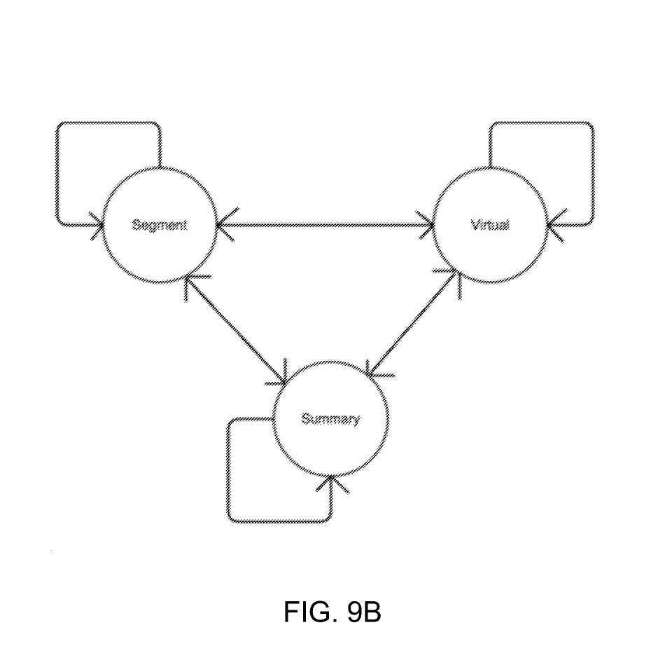

At 316, a modification may be made to kernel scheduling. For example, this may include changing when segments are reshaped in-memory and/or on-disk. Kernel scheduling considers which segments should reside in-memory, which should be purged, and which segments should be perfected from disk into memory based on predictive access patterns via C.R.U.D. Hot segments reside in memory while cold segments are purged. Hot and cold segments are described in greater detail with respect to FIG. 9A. Each kernel schedule task also considers CPU(s) as a resource(s) to be managed and thus will choose preemptive techniques (e.g., context switch) based on optimal processor utilization.

At 318, a modification may be made to an allocation of resources. Such resources may include memory or on-disk storage. For instance, modifying an allocation of resources may include changing segment type and its shape (in-memory and/or on-disk) based on generated models and executed with kernel scheduling. Segment type and shape has a direct correlation to the performance of resources and its ultimate utilization.

Any combination of these aspects may be modified prior to performing the database transaction.

At 320, the database transaction is performed based on the model and with the adjusted attribute.

When it is determined not to adjust a DBMS attribute, at 308, the transaction is performed based on the model. In some aspects, the model may indicate that making an adjustment to an attribute of the DBMS will result in performance gains such as lower transactional costs. Alternatively, in some aspects, the model may indicate that making an adjustment to an attribute of the database may not be optimal. In such aspects, a database transaction may be performed without making any adjustments to any attributes of the DBMS. Factors that influence the model generated at 302 will be discussed with respect FIG. 4.

FIG. 4 conceptually illustrates a process 400 for generating the model discussed above. The process 400 may run continuously until a DBMS reaches a steady state. Once the DBMS reaches a steady state, the process 400 may begin, again, after a state change in the DBMS. Such state changes may include accessing information, and/or performing a read/write operation. The generated model may be used for adaptively managing information in a DBMS to minimize cost and optimize performance using machine learning techniques to predict future information transactions and/or performance needs. The continual analysis described herein provides for an adaptive, dynamic construction/organization of data.

At 402, performance data may be analyzed. Such data may include any combination of resource allocation (404), statistical data (406), including metrics about workload, resources and information (e.g., cardinality, fragmentation, counts), workload (408), including number of DBMS clients/threads, transaction complexity and/or duration, and internal thread scheduling (e.g., split, merge, defragment, compress), data distribution (410), such as level of randomness in the data, cardinality (412), I/O cost (414) and/or performance, CPU cost (416), including number of CPUs, hardware metrics (418) that aggregate data about instructions per second (IPS) performance and context switching, I/O performance, number of and performance of disk storage, information metrics (420) that aggregate the data distribution, cardinality, compression ratios, and data types, and workload metrics (422) that aggregate the DBMS client information, database transaction complexity and/or duration, and internal thread scheduling.

For example, parameters of a hardware model, e.g., analyzed in connection with 418 may include any of a number of CPUs, IPS performance and context switching, a number of drives, and I/O per-second (IOPS) performance.

Example parameters of an information model, e.g., analyzed in connection with 420, may include any of data distribution of sequential versus random, data cardinality, data compression ratios, and data types.

Example parameters of a workload model, e.g., analyzed in connection with 422, may include any of a number of clients (e.g., database clients/threads), a client database transaction complexity/duration, and internal thread schedule/performance of: split, merge, defragmentation, compression, etc.

Using at least one of the analyses performed (at 402), the future workload and/or data transactions can be predicted at 424. The process 400 then returns the generated model. Using the generated model, the DBMS may determine whether adjusting an attribute of the DBMS will result in long term performance benefits while minimizing read/write costs. In some aspects, the process 400 illustrates a machine learning process that is able to better predict how to best optimize the structure, behavior, kernel/thread scheduling, and/or resource allocation to realize the greatest performance gains.

In some aspects of the process, decisions to optimize data may be adaptive. For instance, the process may have determined that a prior attribute adjustment was not optimal for a particular dataset. In such instances, the process may adjust to make more optimal future decisions by learning different behaviors or data patterns associated with the DBMS. In some aspects, the process may determine that better performance gains may be realized by waiting to adjust an attribute of the DBMS. For instance, if an operation such as a defragmentation operation is being performed on the data managed by the DBMS, the process may determine that waiting to write data to the datastore may provide the lowest computational cost for a write operation.

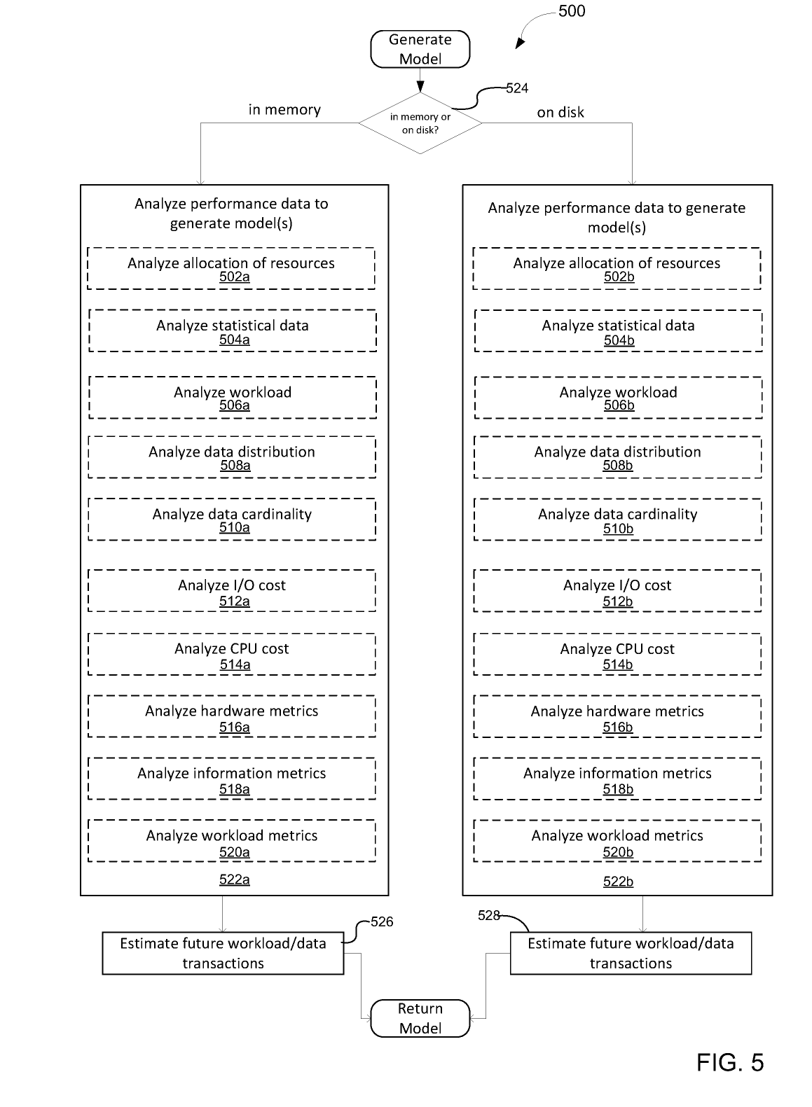

FIG. 5 conceptually illustrates a process 500 for generating the model discussed above, where on disk information is analyzed independently from in memory information. An in-memory representation of the information may be different from a non-transient storage (e.g., on disk) of information. For example, the in-memory representation of information may be optimized independently from the non-transient storage of information, and both representations may be optimized for their respective mediums as illustrated by the process 500.

The process 500 determines (at 524) whether the model is to be generated for information stored on disk or in memory. When the process 500 determines (at 524) that the model is to be generated for information stored in memory, the process 500 may generate at least one model by analyzing (at 522a) performance data. Such data may include resource allocation (502a) statistical data (504a), including metrics about workload, resources and information (e.g., cardinality, fragmentation, counts), workload (506a), including number of DBMS clients/threads, transaction complexity and/or duration, and internal thread scheduling (e.g., split, merge, defragment, compress), data distribution (508a), such as level of randomness in the data, cardinality (510a), I/O cost (512a) and/or performance, CPU cost (514a), including number of CPUs, hardware metrics (516a) that aggregate data about instructions per second (IPS) performance and context switching, I/O performance, number of and performance of disk storage, information metrics (518a) that aggregate the data distribution, cardinality, compression ratios, and data types, and workload metrics (520a) that aggregate the DBMS client information, database transaction complexity and/or duration, and internal thread scheduling.

Using at least one of the analyses performed (at 522a), the process 500 estimates (at 526a) or predicts the future workload and/or data transactions. The process 500 then returns the generated model.

When the process 500 determines (at 524) that the model is to be generated for information stored on disk, the process 500 may generate at least one model by analyzing (at 522b) performance data. Such data may include resource allocation (502b) statistical data (504b), including metrics about workload, resources and information (e.g., cardinality, fragmentation, counts), workload (506b), including number of DBMS clients/threads, transaction complexity and/or duration, and internal thread scheduling (e.g., split, merge, defragment, compress), data distribution (508b), such as level of randomness in the data, cardinality (510b), I/O cost (512b) and/or performance, CPU cost (514b), including number of CPUs, hardware metrics (516b) that aggregate data about instructions per second (IPS) performance and context switching, I/O performance, number of and performance of disk storage, information metrics (518b) that aggregate the data distribution, cardinality, compression ratios, and data types, and workload metrics (520b) that aggregate the DBMS client information, database transaction complexity and/or duration, and internal thread scheduling.

Using at least one of the analyses performed (at 522b), the process 500 estimates (at 526b) or predicts the future workload and/or data transactions. The process 500 then returns the generated model. By isolating on disk information optimization from in memory optimization, the process 500 may provide more granularity in minimizing read/write cost and/or performance of the DBMS.

Over time, the generated models may indicate that Anti-entropy algorithms (e.g., indexing, garbage collection and defragmentation) may be needed to restore order to “random” systems in order to realize greater performance gains and optimal cost minimization. Such operations may be parallelizable and take advantage of idle cores in multi-core systems. The following figure illustrates how anti-entropy algorithm may be used to adaptively manage information in a DBMS.

These aspects of generating the model and continually performing an analysis and possible modification of attributes of the model may include adaptability, intelligence, modeling, and statistics. Aspects may include adaptability, e.g., through the use of split algorithmic behavior (e.g., ordering) from structure, as well as, memory and storage structure independence. Each of these aspects may be continually altered or modified based on the ongoing analysis.

Aspects may include intelligence, e.g., through kernel scheduling techniques for hardware utilization via observing and adapting to workloads and resources. Aspects may include machine learning.

Aspects may include modeling, e.g., to use machine learning to define structure and to schedule resources allowing for continuous online calibration.

Aspects may include the use of statistics, e.g., through embedding metrics regarding workload, resource, and information (e.g., cardinality, fragmentation, counts) for cost modeling.

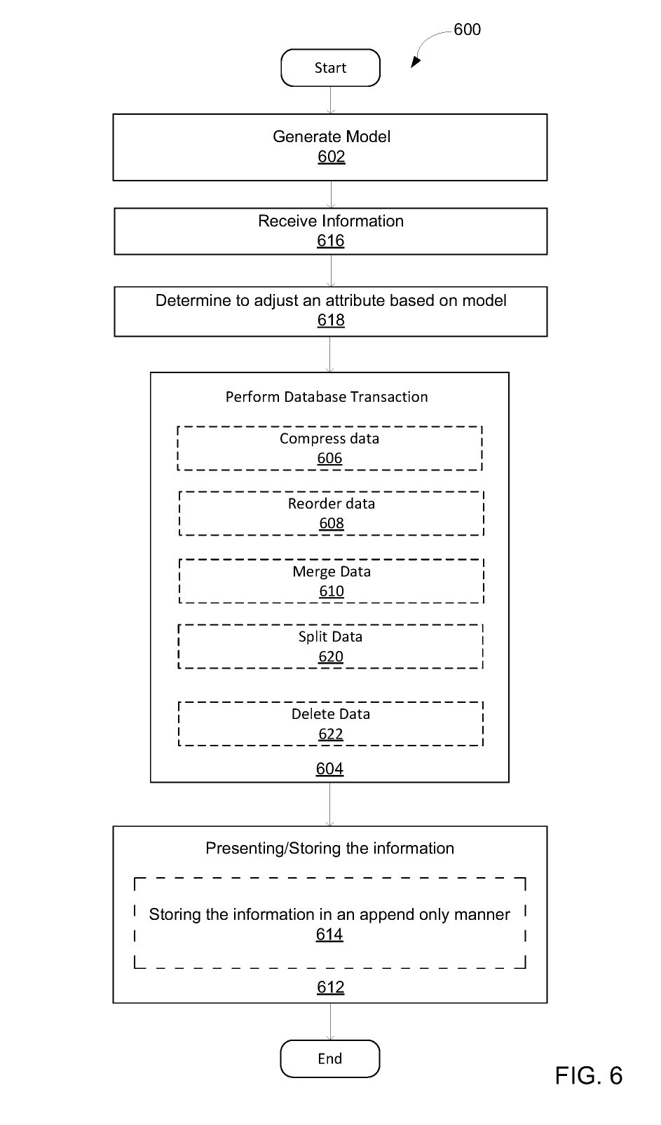

FIG. 6 presents a flow chart illustrating aspects of an automated method 600 of adaptively managing information in a DBMS, in accordance with aspects of the DBMS presented herein. Information may be structured or unstructured and may include relations, objects, binary data and text. The process 600 generates (at 602) a model using machine learning techniques such as various analyses discussed above. At 616, information is received. Information may be received in any automated manner, e.g., information may be received from user input, from web applications, from machine to machine communications, from a standard database or other data repository, file systems, event streams, sensors, network packets, etc. In an aspect, the receipt may be performed, e.g., by a communication component including any combination of processor 104, communication infrastructure 106, interface 120, communication interface 124, and communication path 126 in FIG. 1. At 618, the process 600 determines whether to adjust an attribute of the DBMS based on the model. Such attributes have been discussed above.

At 604, the process 600 performs the database transaction and using the model adjusts a structural attribute of the DBMS for optimal performance and to reduce read/write cost and/or count. This may include any of compressing the data (606), reordering the data (608), merging the data (610), splitting the data (620) and/or deleting the data (622). In an aspect, the transaction may be performed, e.g., by a processor, such as 104 in FIG. 1.

In some aspects of the process, the process may adjust an attribute of the data in order to try to optimize the datastore for future reads and writes. For instance, if data is largely sequential and non-duplicative, the model may indicate that the data is already maximized for future reads. However, if the data is largely random, the process may reorder or rebalance the datastore by performing a defragmentation operation in order to maximize performance for future write operations. Moreover, if the information being received at the datastore comprises many duplicates, the model may indicate that the optimal solution is to wait for all of the duplicate data to come in before compressing the data (e.g., removing duplicates). The ideal solution will yield a datastore that is as small as possible and sequential. The modeling techniques discussed above enable the DBMS to make better long term decisions for the data set rather than poor short term decisions, which are more likely to occur with the traditional B-Tree or LSM-Tree designs. These modeling techniques improve the performance of a B-trees' run time by making the run time no longer affected by the number of elements on each tree branch

At 612, the process 600 then presents or stores the information from the database transaction. In an aspect, the storage may be performed, e.g., by any combination of processor 104, main memory 108, display interface 102, display unit 130, and secondary memory 110 described in connection with FIG. 1. For example, retrieved information may be presented by a standard query mechanism such as SQL relations, objects, binary data and text. The information may be stored, e.g., in transient memory or in a persistent form of memory. Persistent forms of memory include, e.g., any non-transitory computer readable medium, such as tape, disk, flash memory or battery backed RAM. Storage may include storing the organized information in an append-only manner 614. As discussed in the previous figure, an in-memory representation of the information may be different from a non-transient storage of information because the in-memory representation of information may be optimized independently from the non-transient storage of information, and both representations may be optimized for their respective mediums.

An append only manner may include, e.g., only writing data to the end of each file.

Append-only metadata files, e.g., may represent information about the datastore itself and/or file order and schema.

Non-transient information may be stored in files prefaced by append-only headers describing at least one of the file's format, datastore membership, index membership, file identifier and preceding file identifier used for append only file chaining The header may describe the file's format. The description may include a flag, a file type, an encoding type, a header length and/or header data. The information may be, e.g., streamed to and from non-transient mediums.

The information may be created, read, updated and/or deleted as key/value pairs. Keys and values may be fixed length or variable length. Alternatively, the information may be created, read, updated and/or deleted concurrently.

The information may be stored, e.g., at 612, in variable length segments. The segment length may be determined based on policy, optimization of central processing unit memory, and/or optimization of input and output.

The segments may be summarized and hierarchical.

The segments may comprise metadata, the segment metadata being hierarchical. Such segment metadata may include any of computed information related to the information comprised within segments and segment summaries, error detection and correction information, statistical and aggregated information used for internal optimizations including but not limited to defragmentation, statistical and aggregated information used for external optimizations including but not limited to query optimizations, information representing data consistency aspects of segments, information representing physical aspects of the segments, information representing aggregations of segment information, and information generated automatically in the response to queries and query patterns.

The segments may be purged from memory based on memory pressure and/or modeling using continuous adaptive sequential summarization of information.

The segments may be split into multiple segments based on size and/or policy. The segments may be merged based on at least one of size and policy.

The segments may be compact or compressed.

When a segment comprises a compact segment, such compaction may be achieved by identifying longest matching key prefixes and subsequently storing the longest matching key prefixes once followed by each matching key represented by its suffix. There may be longest matching prefixes per segment and those prefixes may be chosen so as to optimize one or more characteristics, e.g., including CPU utilization and segment size.

The segments may comprise error detecting and correcting code.

Variable length segments may be stored on non-transient storage within append-only files which are limited in size and chained together through previous file identifiers in their headers. Such variable length segments may be generalized indexes into the state log of key/value pairs.

The segments may be stored by key and ordered by key in a segment tree and/or an information tree. When segments are stored by key and ordered by key in a segment tree, the segments may be purged from memory to non-transient storage and loaded from non-transient storage into memory.

The segment information may be stored in an information cache. Such stored information may be shared by segments representing primary and secondary indexes.

When the information is created, read, updated and/or deleted as key/value pairs, keys and values may be represented by key elements and value elements, the key elements and value elements being encoded using at least one of a state flag, a fixed size encoding, a size delimited variable size encoding, and a framed variable length encoding. The keys, values, key elements and value elements may be referenced by key pointers and value pointers. The key pointers and value pointers may be fixed length or variable length.

Aspects may further include an automated system for storing and retrieving information, the system including means for receiving information, means for organizing said information for optimal storage and retrieval based on the qualities of a storage medium, and means for, at least one of, presenting and storing said organized information. Examples of such means for receiving, means for organizing, and means for presenting and storing are, e.g., described in connection with FIGS. 1 and 2.

Aspects may further include a computer program product comprising a computer readable medium having control logic stored therein for causing a computer to perform storage and retrieval of information, the control logic code for performing the aspects described in connection with FIGS. 6-12. For example, the control logic may cause a computer to perform receiving information, organizing said information for optimal storage and retrieval based on the qualities of a storage medium, and at least one of presenting and storing said organized information, as described herein.

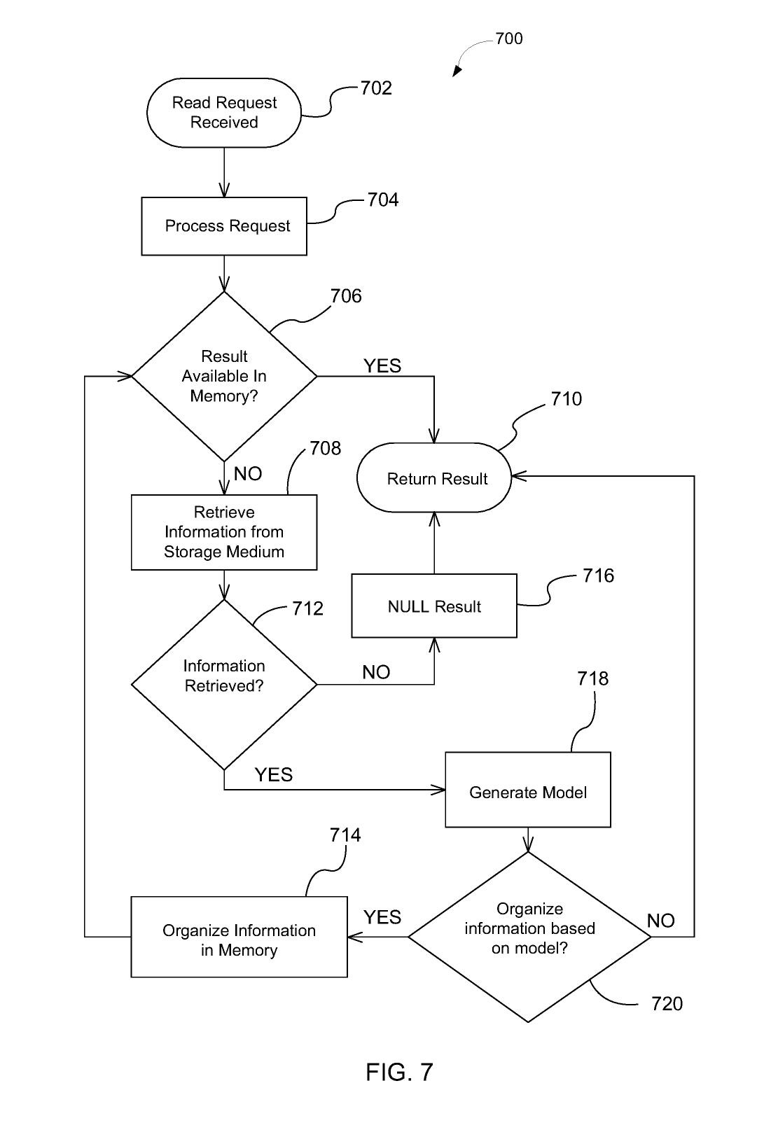

Aspects may further include an automated system for the storage and retrieval of information. The system may include, e.g., at least one processor, a user interface functioning via the at least one processor, and a repository accessible by the at least one processor. The processor may be configured to perform any of the aspects described in connection with FIGS. 7-12. The processor may be configured, e.g., to receive information, organize said information for optimal storage and retrieval based on the qualities of a storage medium, and at least one of present and store said organized information.

FIG. 7 presents a flow chart illustrating aspects of an automated method 700 of receiving 702 and processing 704 read requests for information where that information may be present in main memory or on a storage medium in an append-only manner. When information and results are not available in memory at 706, information is incrementally retrieved from the storage medium from append-only data structures in 708. When information is retrieved, the process 700 generates a model (at 718). The process 700 determines (at 720) whether to organize the information based on the model. When the process 700 determines (at 720) not to organize the information, the process 700 returns (at 710) the result.

When the process 700 determines (at 720) to organize the information based on the model, the information is organized in memory at 714 and memory is rechecked for results at 706. The process continues until results are found at 706 or no further information may be retrieved as determined by 712. When no results are found a NULL return result is set in 716.

Efficient incremental retrieval of information is directed by indexes which are incrementally regenerated from the storage medium where they were stored in an append-only manner.

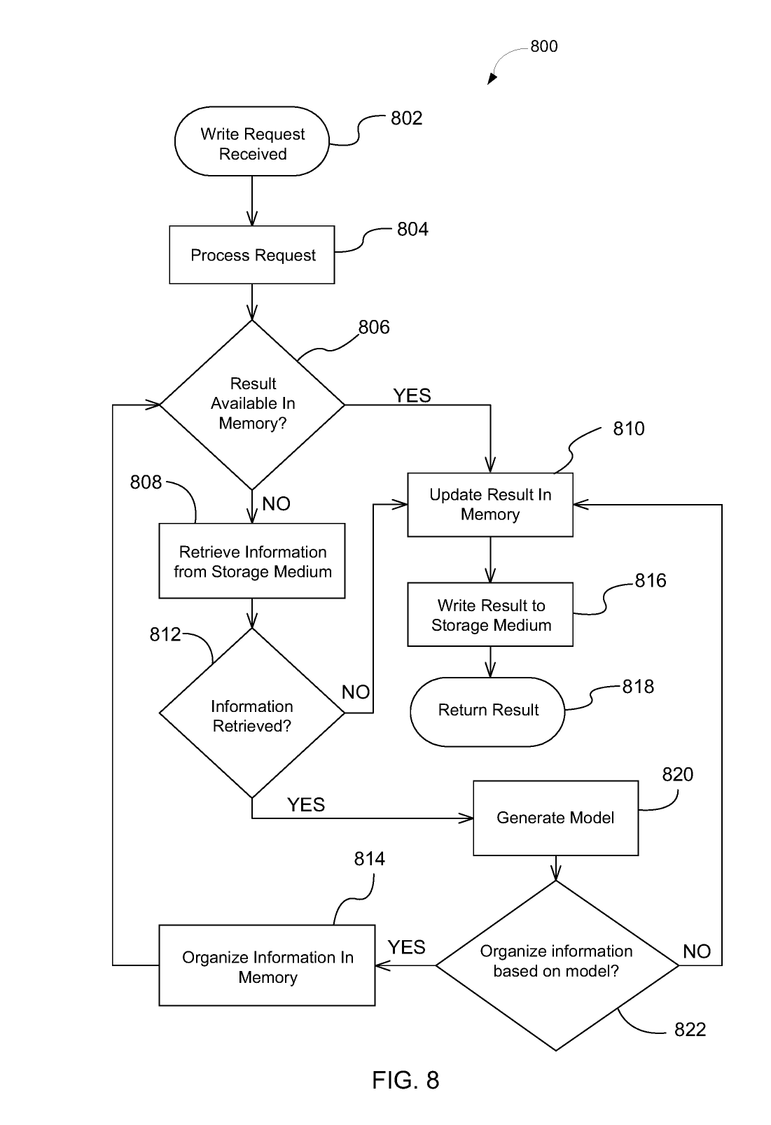

FIG. 8 presents a flow chart illustrating aspects of an automated method 800 of receiving 802 and processing 804 write requests for information. In one example, that information may be present in main memory or on a storage medium in an append-only manner. When a write request is received main memory is checked in 806 to determine if that result is already available in main memory. If the result is not available in main memory information is incrementally retrieved from the storage medium from append only structures in 808. When information is retrieved, that information is organized (e.g. ordered) in memory (i.e. segments) at 814 and memory is rechecked for results at 806.

The process continues until results are found at 806 or no further information may be retrieved as determined by 812. When the process 800 determines (at 812) that the information was retrieved, the process 800 generates (at 820) a model. The process 800 then determines (at 822) whether to organize the information based on the model. When the process 800 determines (at 822) to organize the information, the process 800 organizes (at 814) the information and determines (at 806) whether the results are available in memory. In either case, the write result is updated in memory at 810, written to the storage medium at 816 and returned at 818.

FIG. 9 illustrates an exemplary adaptive control structure within a DBMS logical tree structure. For example, FIG. 9 illustrates individual sub-tree structures that physically make up a complete logical tree structure. Using sub-trees for the complete logical tree structure allows for adaptive controlling of the physical sub-trees via generating models for machine learning techniques.

As shown, the logical tree includes a single root segment 905 at the top of the tree. An adaptive layer 925 is located below the root. The adaptive layer utilizes machine learning techniques, such as those discussed with reference to the preceding FIGs, to adjust attributes (e.g., defragment, split, compress, merge) within the DBMS. Subtrees 930 may comprise at least one segment 920, a virtual segment 915, and/or a summary segment 910, which may be located below the adaptive layer. Each subtree may be associated with a key and a value. Key/value pairs have been described in detail in U.S. Patent Publication No. 2013/0226931.

In this example, a segment may be associated with a key and information. The segment may be derived from the TreeMap class, while also including instructions for how to apply the various machine learning techniques described herein. The physical segment, similar to segment 920 may represent all elements in the segment. Physical segments are fully instantiated subtrees that include all associated elements. The virtual segment 915 may also be associated with a key and information. However, the virtual segment 915 is not fully instantiated and may include less elements than a physical representation of the virtual segment 915 may include. For instance, the virtual segment 915 may be a logical abstraction of a segment that does not include all key/value pairs that supports all of the same operations supported by a physical segment without constructing the entire segment from disk memory. It follows that the best case complexity for a virtual segment is O(1). Virtual segments become useful when the adaptive layer 925 purges a physical layer from memory. The adaptive layer 925 is discussed in greater detail below.

The summary segment 910 may be associated with a key and segment data. The summary segment 910 may be used to dither abstraction of segments and aggregate segment information. The purpose of the summary segment 910 is to collapse large regions of the key-space. Summary segments are useful for providing statistics (metadata) as well as locality of data in storage. Such statistics can be used in conjunction with other systems such as query optimizers. For instance, the summary segment 910 may summarize the cardinality of subtrees, which cuts down on seek costs because it negates the need for an algorithm to traverse all of the subtrees. It follows that summary segments improve read performance by minimizing the inputs to the tree.

The adaptive layer 925 of FIG. 9 determines all of the characteristics of the tree. The overall look and structure of the tree is dependent upon the decisions made by the adaptive layer 925. For instance, the adaptive layer 925 may utilize the modeling and machine learning techniques discussed above to optimize the read/write performance of the DBMS by modifying an attribute of the subtrees or segments 930. In such instances, the adaptive layer 925 may utilize the machine learning techniques to change at least one of the segments 930. In other words, the adaptive layer 925 makes decisions about when and if to change the type of segments. The purpose of these decisions is to minimize resources used for operations. For example, to minimize resources, the adaptive layer 925 may convert a physical segment into a virtual segment in order to purge a physical segment from memory. The virtual segment may maintain an abstract representation of the data it holds so that the entire segment does not have to be pulled out of storage to operate. Thus, utilizing the virtual segment may minimize the resources and seek time needed to perform an operation. FIG. 9B illustrates a state diagram of how a segment may change state or maintain the same state.

Furthermore, the adaptive layer 925 makes predictions about which parts of the tree are likely to be hot in the future and adjusts the tree accordingly. The techniques used by the adaptive layer 925 can be described using a Markov Decision Process. The statistical technique is used to model processes that have different states. For instance, data that is currently hot, or being operated on, can either continue being operated on, stop (e.g., turn cold). The frequency with which a chunk of data is operated on is described as the weight of a segment where weight is the rate of change. By measuring the probabilities of each of these events, the adaptive layer 925 takes the data that is most likely to become hot or remain hot and ranks it in order according to weight. The adaptive layer 925 then uses these predictions to greatly increase performance by allocating hardware resources accordingly. The same process may be used to determine whether to convert segment (e.g., a physical segment to a virtual segment).

In an exemplary embodiment, the adaptive layer 925 may use modeling and adaptive learning techniques to learn the nature of the data that is coming into the DBMS. If the adaptive layer 925 recognizes that the data is sequential, then the adaptive layer 925 may recognize that older segments may be purged quicker because the nature of the data indicates that the segments will be stored on disk. Alternatively, if the adaptive layer 925 recognizes that the data coming into the DBMS is random, then the adaptive layer 925 may recognize that some segments will have to be purged while it may be more efficient to keep certain segments in memory. For instance, if the adaptive layer 925 recognizes that a segment is cold, or less likely to be operated on, the adaptive layer 925 may purge that particular segment while maintaining hot segments, or segments that are being operated on. Accordingly, the adaptive layer 925 makes predictions about the nature of the data coming into the DBMS and makes decisions based on those predictions. Such decisions may include which segments are hot or cold, and what segments are purged or kept in memory.

The following figures discuss, in greater detail, the various operations that may be used to optimize read/write performance using machine learning techniques and by handling a segment change such as merging segments, splitting segments, defragmenting data and/or compressing data.

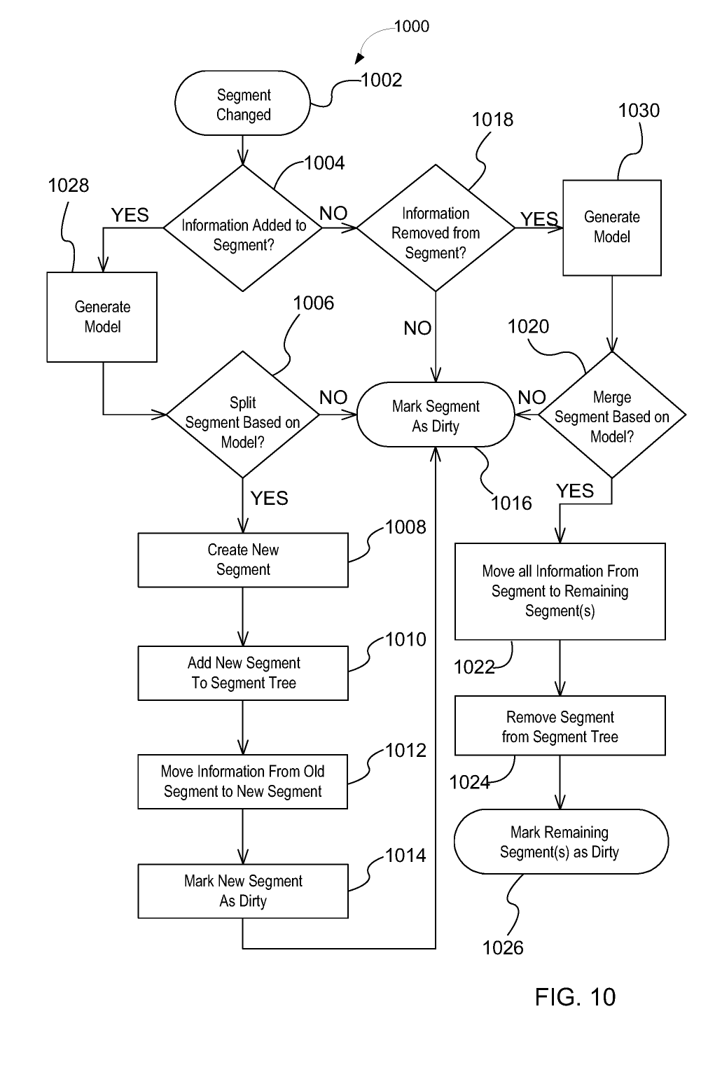

FIG. 10 presents a flow chart illustrating aspects of an automated method 1000 of handling segment changes starting at 1002. A segment changes when information is added to it, checked at 1004, or is removed from it, checked at 1018. When information is added to a segment, a model is generated at 1028 and that segment may need to be split in 1006 based on the generated model. If the segment is split a new segment is created in 1008 and that new segment is added to the segment tree in 1010. After creation and insertion the new segment is filled with a percentage of the information from the old segment by moving that information from the old segment to the new segment in 1012. The new segment is then marked as dirty at 1014 and the old segment is marked as dirty at 1016.

If information was not added to the segment a check is done at 1018 to determine if information was removed from the segment. If information was not removed from the segment the segment is marked as dirty in 1016. When enough information is removed from a segment, a model may be generated at 1030, and as determined by the generated model in 1020, the segment may be merged with adjacent segments. When a segment is merged all of its information is moved into one or more remaining segments in 1022 and the emptied segment is removed from the segment tree in 1024. Finally, the remaining segments accepting the merged information are marked as dirty in 1026.

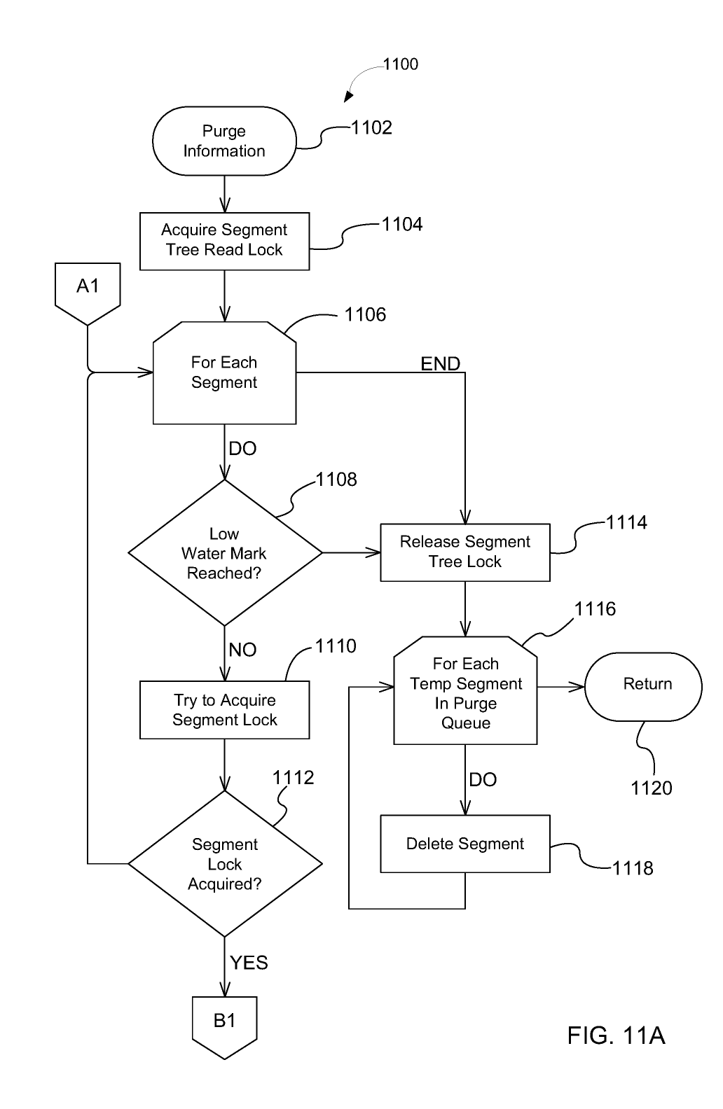

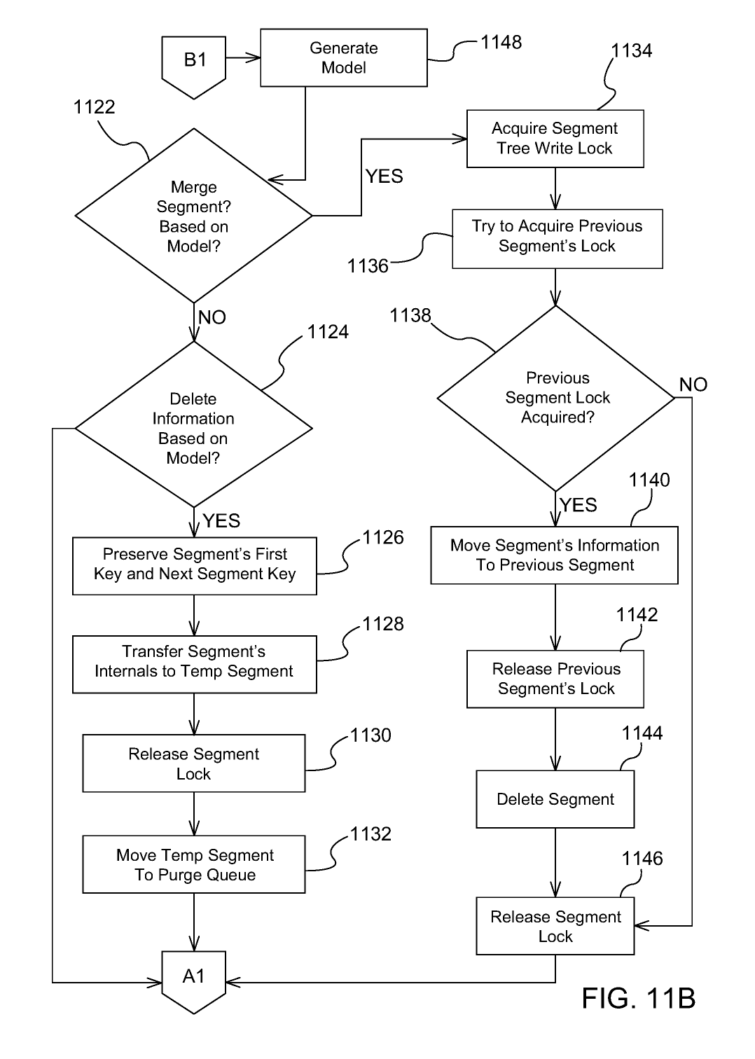

FIGS. 11A and 11B present flow charts illustrating aspects of an automated method 1100 of memory management and information purging starting at 1102. When information must be purged to free up memory segments the segment tree read lock is acquired at 1104 and segments are ordered for deletion by policy (e.g. least recently used) starting at 1106. At 1106 each segment is traversed until the low water mark is reached at 1108 or the starting point for segment traversal is reached (segment traversal at 1108 maintains state and traverses each segment in a circular manner). If the low water mark is not reached an attempt is made to acquire the segment lock in 1110 and if the segment lock is not acquired at 1112 the next segment is traversed starting at 1106.

If the segment lock is acquired at 1112, a model is generated at 1148 and the segment is checked to determine if it should be merged at 1122 based on the model. If the segment should be merged the segment tree's read lock is upgraded to a write lock at 1134 and an attempt to acquire the previous segment's lock is made in 1136. If the previous segment's lock is not acquired segment lock is released at 1146 and the next segment is processed at 1106. When the previous segment's lock is acquired at 1138 the traversed segment's information is moved to the previous segment in 1140. Next, the previous segment's lock is released at 1142 and the traversed segment is deleted in 1144. Finally, the segment's lock is released at 1146 and the next segment is processes starting at 1106.

When a segment should not be merged at 1122, policy is used to determine whether the information should be deleted based on the model at 1124. If the information should be deleted based on deletion policy the segment's first key and next segment key are preserved at 1126. Once the keys are preserved the segment's internals are transferred to a temp segment in 1128, the segment lock is released at 1130 and the temp segment is moved to the purge queue in 1132. Once the temp segment is in the purge the next segment is processed starting at 1106.

After the low water mark is reached in 1108 or all segments have been traversed in 1106 the segment tree's lock (read or write) is released in 1114 and then each policy ordered temp segment in the purge queue is traversed in 1116 and deleted in 1118. Once all temp segments are deleted the process returns in 1120.

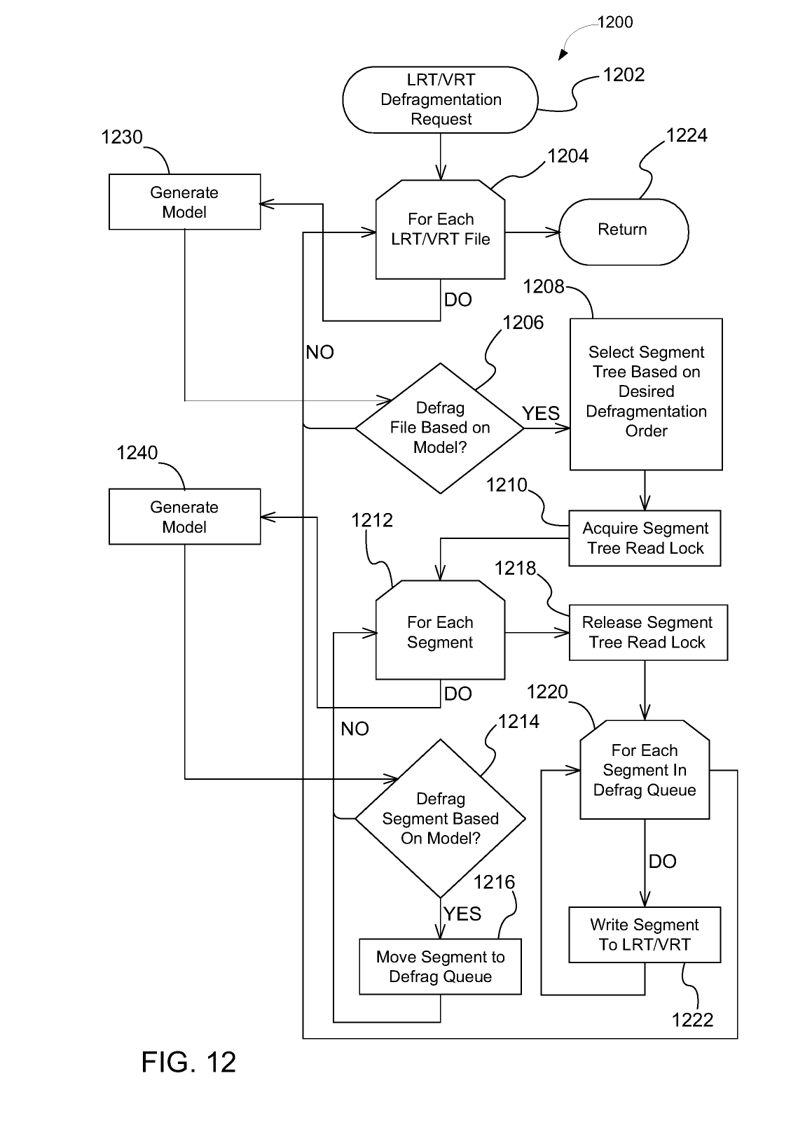

FIG. 12 presents a flow chart illustrating aspects of an automated method 1200 of receiving a LRT/VRT file defragmentation request at 1202 and processing that request for each LRT/VRT file under management. Those of ordinary skill in the art will recognize that the method 1200 may be similarly applied to IRT files. LRT/VRT files are similar to IRT files in that LRT/VRT files comprise row data while IRT files comprise indexed data. LRT, VRT, and IRT files all have similar requirements for defragmentation, which is further described in U.S. Patent Publication No. 2013/0226931.

At 1204 each LRT/VRT file is traversed and a model is generated at 1230. The model is used to determine if the file should be defragmented at 1206. If the file should not be defragmented the next LRT/VRT is checked starting at 1204.

When a LRT/VRT file needs to be defragmented the desired defragmentation order is specified by selecting the appropriate segment tree at 1208. Once selected the segment tree read lock is acquired in 1210 and then each segment in the segment tree is traversed in 1212. A model is then generated at 1240. At 1214 the model is used to determine if a segment must be defragmented. When a segment must be defragmented it is moved to the segment Defrag Queue in 1216 and the next segment is traversed in 1212. If the segment is not defragmented at 1214 the next segment is traversed in 1212.

Once all segments have been traversed in 1212 the segment tree read lock is released at 1218 and each segment in the Defrag Queue is traversed in 1220. As each segment is traversed it is written to the LRT/VRT file at 1222 and the next segment is traversed at 1220. Once all segments have been traversed the next LRT/VRT file is traversed at 1204. After all LRT/VRT files are traversed the process returns at 1224.

Aspects presented herein may include an automated apparatus for adaptively managing information in a database management system, the apparatus including means for generating a model associated with the database management system; means for receiving information for performing a database transaction; and means for determining, based on the generated model and the database transaction, whether to adjust an attribute associated with the database management system. These means may include, e.g., a processing system configured to perform aspects described in connection with FIGS. 3-12.

While aspects presented herein have been described in conjunction with the example aspects of implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope hereof. Therefore, aspects are intended to embrace all known or later-developed alternatives, modifications, variations, improvements, and/or substantial equivalents.

What is claimed is:

1. A computer assisted method for adaptively managing information in a database management system, the method comprising:
generating a model associated with the database management system;
receiving information for performing a database transaction; and
determining, based on the generated model and the database transaction, whether to adjust an attribute associated with the database management system.

2. The method of claim 1, wherein said determining is performed in order to optimize at least one of read and write performances in the database management system.

3. The method of claim 2, wherein the write performance has a seek cost or operational count of O(0).

4. The method of claim 2, the read performance has a seek cost or operational count of O(1).

5. The method of claim 1, wherein the attribute comprises a data structure.

6. The method of claim 1, wherein the attribute comprises a kernel scheduling method.

7. The method of claim 6, wherein the generated model comprises hardware resource data comprising a number of CPUs, volatile memory resources, and non-volatile memory resources.

8. The method of claim 7, wherein the kernel scheduling method is adjusted based on the hardware resource data.

9. The method of claim 1, further comprising continuously performing said generating and said determining until the information in the database management system reaches a steady state.

10. The method of claim 1, wherein the attribute comprises a data structure, wherein said determining comprises determining whether to adjust at least one of a data structure and an algorithm performed on the data structure, and wherein the algorithm is independent of the data structure.

11. The method of claim 1, wherein said generating comprises generating at least one of a hardware model, an information model, and a workload model.

12. The method of claim 11, wherein data derived from the hardware model, the information model, and the workload model is aggregated in order to determine whether to adjust the attribute of the database management system.

13. The method of claim 11, wherein the generating the hardware model comprises generating statistical data from at least one of a number of CPUs, instructions per second performance and context switching, number of disk drives, and input/output per-second performance.

14. The method of claim 11, wherein the generating the information model comprises generating statistical data from at least one data distribution, data cardinality, data compression ratios, and data types.

15. The method of claim 11, wherein generating the workload model comprises generating statistical data from at least one of a number of database clients, client database transaction complexity, client database transaction duration, performance of internal thread scheduling.

16. The method of claim 11, wherein the attribute is segment length, wherein the information in the database management system is stored in variable length segments and wherein adjustments to the segment length are determined based on the at least one of the generated models.

17. The method of claim 16, wherein at least two of the segments are merged based on the at least one of the generated models.

18. The method of claim 16, wherein one of the segments is split based on the at least one of the generated models.

19. The method of claim 16, wherein one of the segments is purged from memory based on the at least one of the generated models.

20. The method of claim 16, wherein the segments are defragemented based on the at least one of the generated models.

21. The method of claim 1, wherein the generated model continuously adapts to changes in the database management system, wherein said changes comprise reading or writing information to the database management system.

22. The method of claim 1, wherein an in-memory representation of the information comprises a structure different from a non-transient storage of the information.

23. The method of claim 22, further comprising adjusting the structure of the in-memory representation of the information independent of any adjustments to the structure of the non-transient stored information.

24. The method of claim 22, further comprising adjusting the structure of the non-transient stored information independent of any adjustments to the structure of the in-memory representation of the information.

25. The method of claim 1, wherein said determining comprises predicting performance of the database management system based on the transaction and the generated model.

26. The method of claim 25, further comprising adjusting an attribute of the database management system based on the predicted performance.

27. The method of claim 25, further comprising foregoing an adjustment to the attribute of the database management system based on the predicted performance.

28. An automated apparatus for adaptively managing information in a database management system, the apparatus comprising:
means for generating a model associated with the database management system;
means for receiving information for performing a database transaction; and
means for determining, based on the generated model and the database transaction, whether to adjust an attribute associated with the database management system.

29. An apparatus configured to adaptively manage information in a database management system, the apparatus comprising:
a processor configured to:
generate a model associated with the database management system;
receive information for performing a database transaction; and
determine, based on the generated model and the database transaction,
whether to adjust an attribute associated with the database management system.

30. A computer program product comprising a non-transitory machine readable medium having control logic stored therein for causing a computer to adaptively manage information in a database management system, the control logic comprising code for:
generating a model associated with the database management system;
receiving information for performing a database transaction; and
determining, based on the generated model and the database transaction, whether to adjust an attribute associated with the database management system.
